(19) United States
(12) Patent Application Publication
(10) Pub. No.: US 2024/0132385 A1
(43) Pub. Date: Apr. 25, 2024

(54) Biological Wastewater Treatment System

(71) Applicant: Inspired Water Technology Inc., DOVER (DE)

(72) Inventors: Robert Wiley, Pittsburgh, PA (US); Donato Massignani, Vicenza (IT); John Larson, Oley, PA (US)

(21) Appl. No.: 18/383,455

(22) Filed: Oct. 23, 2023

Related U.S. Application Data
(60) Provisional application No. 63/537,196, filed on Sep. 7, 2023.
(60) Provisional application No. 63/418,939, filed on Oct. 24, 2022.

(51) Int. Cl. C02F 3/30

(52) U.S. Cl. CPC C02F 3/301; C02F 2003/003

(57) ABSTRACT

A biological wastewater treatment process utilizes biology carriers having recesses or pores defined on their surfaces. Biology form a biofilm or granular biofilm on the surface of the biology carriers and within. The pores or recesses protect the biology. As dissolved oxygen is consumed by biology close to the openings of the recesses or pores, less dissolved oxygen reaches biology living deeper within the pores. The pores thereby define aerobic, anoxic, and anaerobic regions within each biology carrier. Some examples of the biology carriers may be made at least in part from biochar or other partially charred materials. The resulting biological process requires less physical space than conventional flocculant sludge based processes and is more readily established and maintained verses traditional aerobic granular sludge.

### CROSS REFERENCE TO RELATED APPLICATION

This application claims the benefit of U.S. provisional patent application Ser. No. 63/418,939, which was filed on Oct. 24, 2022, and entitled “Biological Wastewater Treatment System.” This application also claims the benefit of U.S. provisional patent application Ser. No. 63/537,196, which was filed on Sep. 7, 2023 and entitled “Granular Water Treatment Material Having Controlled Buoyancy.”

### TECHNICAL FIELD

The present invention is directed to the treatment of municipal or industrial wastewater. More particularly, a system for biologically treating the wastewater anaerobically, aerobically, and/or anoxically using biology carried within or on granular cavities for receiving some of the biology.

### BACKGROUND INFORMATION

Treatment of wastewater for discharge or reuse has a long history. Treatment processes may include primary treatment, intermediate treatment, secondary treatment, and tertiary treatment. Initially, solids are removed through primary treatment, which can be accomplished using large tanks in which particles settle to the bottom, or using filters. Examples of filtration systems include U.S. Pat. No. 5,087,358, which was issued to Donato Massignani on Feb. 11, 1992, as well as U.S. Pat. No. 6,500,331, which was issued to Donato Massignani on Dec. 31, 2002. The entire disclosure of both of these patents is expressly incorporated herein by reference. The goal of intermediate treatment is adjusting the conditions within the water in order to facilitate secondary biological treatment. Secondary treatment utilizes biology to degrade and assimilate organic substances in the water for their removal from the wastewater stream. Secondary treatment typically involves the clarification of the biologically treated water, retaining the majority of the biology within the system for continued biological assimilation of the organic substances. Continuously or periodically a portion of the biology which assimilates these organic substances is then wasted from the system to export these nutrients and allow for continued growth and assimilation with the system. As used herein, biology or variants thereof is defined as referring to bacteria, bacterial biofilm including granular biofilm, algae, yeasts, or other beneficial micro-organisms. Tertiary treatment involves filtering biological or inorganic solids from the secondary treatment process. An example of a suitable filtration system is U.S. Pat. No. 9,808,747, which was issued to Donato Massignani on Nov. 7, 2017, the entire disclosure of which is expressly incorporated herein by reference.

Presently known secondary treatment systems include activated sludge systems and biofilm-based systems as well as their derivatives such as integrated fixed film activated sludge (IFAS) systems, as well as moving bed biological reactors (MBBR). Activated sludge processes utilize biology which is suspended within the process tank and recirculated through the process to maintain sufficient quantities of biology within the system for assimilation of the organics and nutrients from the wastewater. Periodically or continuously a portion of the biology is wasted, typically termed waste activated sludge to remove a portion of the biology allowing for continued growth within the system MBBR systems traditionally move the wastewater through various treatment stages with the media being held within each of these zones via screens. In some instances, this process has been improved by allowing the biofilm carriers to flow through various treatment stages to be subjected to anaerobic, aerobic, and/or anoxic conditions, and the biofilm carriers are filtered from the wastewater at the end of the process stream and then the biofilm carriers are placed back at the beginning of the process stream. IFAS systems utilize solid objects (biofilm carriers) or fixed media which are placed in the process tank to allow the biology to live on these objects as well as the recirculation of flocculant biology through the process similar to activated sludge. Another derivative of this process is the Nuvoda MOB process which uses powdered Kenaf fiber as the carrier and operates with recirculation of both flocculant sludge and biological carriers.

The biology in a secondary wastewater treatment process can be anaerobic, aerobic, anoxic, or facultative. Facultative biology can function aerobically or anaerobically, depending on their environment, although they prefer aerobic environments. Different biology which utilize different processes are used for different portions of the process of breaking down contaminants. Nutrient removal and/or nutrient harvesting from wastewater is considered the future of wastewater treatment to both protect the environment where the water is being discharged and also to harvest these resources. Carbon, nitrogen, and phosphorus are the primary nutrients which are targeted for limiting their discharge, with phosphorus recovery being the most desired due to its scarcity and value for agriculture and industry. Optimal removal of these contaminants is accomplished by subjecting the water to anaerobic, anoxic, and/or aerobic processes which typically requires sequentially transferring the water to separate process tanks for each of these processes or it can be accomplished in one tank by cycling through these conditions in time, such as is done in sequencing batch reactors (SBR's).

Aerobic granular sludge is an emerging wastewater treatment process utilizing naturally forming sludge granules which produce aerobic, anoxic, and anaerobic zones, with aerobic processes occurring on the outside of the granule, and anoxic and anaerobic processes occurring within the depth of the granule. All three processes can thus occur simultaneously under bulk aerobic conditions within a reactor. However, these processes have proven to be difficult to establish and have typically only been applied to batch type processes like SBR's previously described, which limits their application in the retrofitting or updating of the majority activated sludge based processes. They typically require very deep reactors for retaining the granules and a feast/famine regime in providing the carbon substrate, and require higher mixing shear forces to achieve the desired sludge granulation, as compared to similar flocculant based activated sludge systems. Granular sludge process often present a challenge for forming and maintaining granules, as they can take many months to be formed within the system and if the process conditions are not maintained to adequately support the granules in this feast/famine regime, they can degrade and disintegrate. While these systems can be difficult to establish and maintain the granules, it has been found that these systems have the potential to rapidly perform full nitrification/denitrification and phosphorus removal to a high degree in lab-scale testing, but in practice the nature of the granule limits diffusion of the substrate into the granules such that only the soluble or readily soluble portion is effectively degraded vs traditional activated sludge which maintains a flocculant biology that can more effectively access partially soluble organics for performing their biological functions.

Accordingly, there is a need for a secondary treatment system which carries out anaerobic, anoxic, and aerobic processes in a more efficient and preferably simultaneous manner. There is an additional need for an aerobic granular sludge process which is able to rapidly establish the biological granules within the system. There is an additional need for an aerobic granular sludge process which is able to be designed in continuous flow type systems for retrofitting existing conventional active sludge type processes, verses batch type operation in specially constructed deep reactors, which is the norm for current aerobic granular sludge process.

### SUMMARY

The above needs are met by a biological wastewater treatment method. The method comprises providing a biological reactor and providing biology carriers within the biological reactor. The biology carriers has biology thereon. Un-biologically treated water is placed into the biological reactor. The un-biologically treated water is treated anaerobically, aerobically, and anoxically within the biological reactor to produce biologically treated water. The biologically treated water is separated from the biology carriers, which are then returned to the biological reactor.

These and other aspects of the invention will become more apparent through the following description and drawings.

### BRIEF DESCRIPTION OF THE DRAWINGS

FIG. 1 is a cross sectional view of an example of a rice hull for use with a biological wastewater treatment system.

FIG. 2 is a cross sectional view of a portion of the rice hull indicated by the circle 2 in FIG. 1.

FIG. 3 is a front elevational view of a plurality of clusters of granules of rice hulls of FIG. 1 or other biochar.

FIG. 4 is a perspective view of an example of a biology carrier made from a polymer combined with the biochar of FIG. 1.

FIG. 5 is a schematic overview of an example of a wastewater treatment system.

FIG. 6 is a partially schematic side elevational view of a biological reactor for a biological wastewater treatment system of FIG. 3.

FIG. 7 is a perspective view of a filter apparatus for use with the biological wastewater treatment systems of FIGS. 3 and 4.

FIG. 8 is a flowchart illustrating an example of process steps for the biological wastewater treatment utilizing the system of FIG. 3.

FIG. 9 is another flowchart illustrating an example of process steps for the biological wastewater treatment utilizing the system of FIG. 3.

Like reference characters denote like elements throughout the drawings.

### DETAILED DESCRIPTION

Referring to the drawings, a biological wastewater treatment process is illustrated. Biological treatment will typically be performed as a secondary treatment process, after a primary filtering step, although the invention is not limited to this sequence of steps, and may include processes which solely utilize biological treatment. Some examples of biological treatment may also be followed by a tertiary treatment process which includes additional filtering. An example of a sequence of primary and secondary treatment processes is disclosed in US 2023/0002264, which was invented by the present inventors, published on Jan. 5, 2023, and is entitled “Wastewater Treatment System for Improved Primary Treatment and Volatile Fatty Acid Generation,” the entire disclosure of which is expressly incorporated herein by reference.

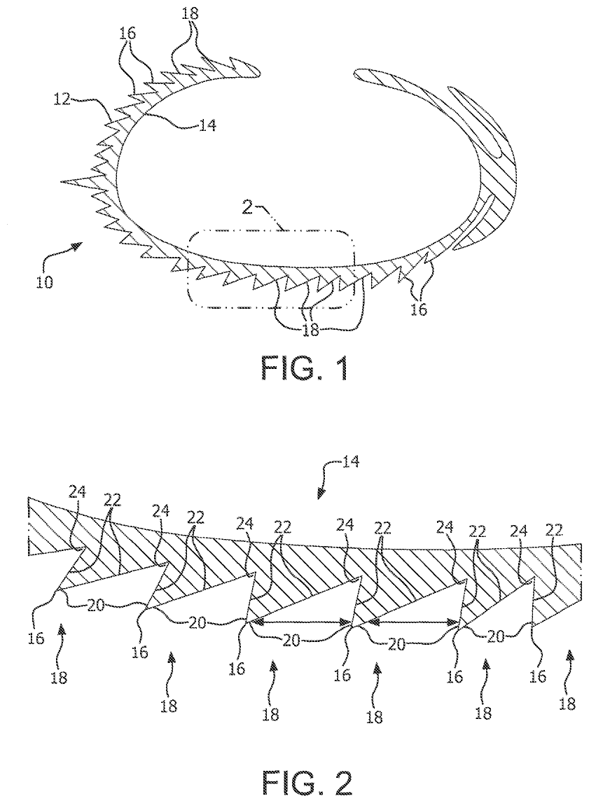

Referring to FIG. 1, the system utilizes a plurality of granules 10. The granules 10 in the illustrated example are mostly within the size range of about 0.5 mm to about 25 mm. Some examples of the granules 10 are made from biological wastes such as agricultural residuals or can be generated from the biosolids produced in the wastewater process. Some examples of biological wastes include rice hulls, rice husks, rice straws, corn cob, corn stover, seed or nut shells, wood wastes or various other organic materials from agriculture or forestry for example, but are not limited to these examples only. Some examples of biological wastes are partially or totally pyrolyzed or charred, for example, grass biochar or wood biochar, as well as biochars of the above-mentioned biological wastes. Examples of granules 10 which are partially or totally pyrolyzed are referred to herein as biochar, which is the solid material obtained from the thermochemical conversion of biomass in an oxygen-limited environment. The example illustrated in FIG. 1 is a partially or totally pyrolyzed rice hull 10. Some examples of the granules 10 are hydrophilic to facilitate biology forming a biofilm on the surface of the biochar. To the extent that the granules are not charred, they can also serve as a carbon source for the biofilm living thereon. Some examples of the granules 10 will have a specific gravity of about 1.0 to about 1.5 when saturated with water. Some examples of the granules 10 may have a specific gravity of about 1.0 to about 1.2 when saturated with water. This specific gravity facilitates settling of the granules 10 when desired, while also requiring minimal agitation to keep the granules 10 suspended in water when desired. Some examples of the granules 10 will have a specific gravity of about 0.1 to about 1.0 when saturated with water. This specific gravity facilitates floatation of the granules 10 when desired, while also requiring minimal agitation to keep the granules 10 suspended in water when desired.

The illustrated example of a granule 10 defines an exterior surface 12 and an interior surface 14. The interior surface may not be present if other source materials are used and may form a more spherical shape with the pores extending into the center of the material. Some examples of the granules 10 have a specific surface area between about 50 m²/g and about 900 m²/g, thus providing increased surface area for a biofilm to form on the surface of the granules 10. The exterior surface 12 includes multiple projections 16 defining recesses 18 therebetween. Recesses or pores having a width W greater than about 0.5 μm facilitate biology inhabiting the recesses or pores. When the granules 10 are placed in a biological treatment reactor, biology adhere to the surfaces 12, 14, including within the recesses 18. The recesses 18 serve to protect biology therein, and for the example of a rice hull, the interior surface 14 may also provide a protected area for biology as well. The recesses 18 also help to define aerobic, anoxic, and anaerobic regions on each granule 10. It is anticipated that biology on surface 12 located near an outside portion 20 of a recess 18, or otherwise on the surface 12 outside of a recess 18, will have the greatest access to dissolved oxygen for engaging in aerobic respiration. Less dissolved oxygen is anticipated to reach a central portion 22 of the recesses 18, because at least some of the oxygen is consumed by biology on the outside 20 of the recesses 18. Biology in the central portion 22 of each recess 18 are therefore likely to engage in anoxic respiration within at least some biological reactors. Similarly, biology within an inner portion 24 of each recess 18 is likely to receive even less dissolved oxygen, since biology in each outer region 20 and central region 22 are anticipated to consume a large portion of the available oxygen. Biology in the inner region 24 of each recess are therefore likely to be anaerobic within at least some biological reactors.

Other examples of the granules 10 may be made from sponge or other inorganic absorption media. Still other examples of the granules 10 may include recycled plastic material or charred plastics to increase porousness for the biology to reside on and within.

The granules 10 may be treated either before use, or after predetermined time periods, predetermined number of treatment cycles, or predetermined volume of water treated so that the hydrophilicity, absorptive capacity, or ion exchange capacity is increased. This treatment may occur in situ or ex situ.

The hydrophobicity of the biochar as well as the oleophilicity (useful if using the biochar to carry biology or for acting as an absorptive media) can be increased with various surface treatments. For example, oils such as linseed oil, which is a known polymerizing oil, or tung oil may be used to treat the porous structure of the biochar granules 10. This type of treatment preserves all of the advantages of using biochar as biofilm carriers, while rendering the material substantially hydrophobic.

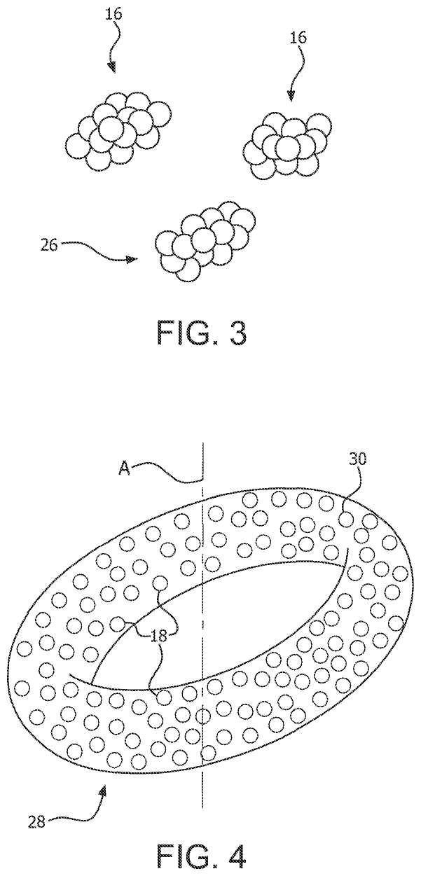

In other examples of biology carriers, the granules 10 are combined with a polymer or other low density binder in a manner which occludes a portion of the recesses within the granules 10, thus resisting the ingress of water and increasing the buoyancy of the granules. The low density of the polymer or other binder also increases buoyancy. Some examples of the resulting carriers will have a buoyancy of about 1.5 (negatively buoyant or sinking) to about 0.8 (positively buoyant or floating) when saturated with water. Other examples of the carriers will have a buoyancy of about 0.95 to about 1.05 when saturated with water. Still other examples of the carriers will have a buoyancy of about 1.0 (neutral) when saturated with water. At least a portion of the recesses in the granules remain so that the recesses defined within the granules remain available for inhabitation by biology. Some examples of the binders may also have adhesive properties, causing the granules 10 to cluster together to form larger biology carriers 26, as illustrated in FIG. 3.

Referring to FIG. 4, an example of a polymer base 28 is combined with multiple granules 10 to form a biology carrier. At least some granules 10 are accessible to biology on the surface of the base 28. The base 28 is configured in a manner which provides ease of manufacture, for example, by extrusion or other molding process. In some examples, the polymer base is structured to provide some physical protection to at least some of the granules 10. FIG. 4 illustrates a toroidal shape base 28, having a surface 30 which is at least partially covered by granules 10. The base 28 is easily made, for example, but extruding a tube and then cutting it into bases 28. Some examples of the base 28 may have the form of a circle or oval rotated around an axis A parallel to one of its edges. Other examples may have the form of a rectangle or square rotated around an axis parallel to one of its edges. Granules 10 which are located closest to the axis A will have some physical protection from the shape of the base 28. A wide variety of other base shapes may be utilized without departing from the invention.

The polymer base 28 may be made from a variety of polymers, with examples including polypropylene, low density polyethylene, and high density polyethylene among other various thermoplastics or other polymers. The granules may be added by melting or partially melting the polymer base 28, and then adding the granules 10 to the surface so that at the base cools, it solidifies around portions of the granules to secure them in place. Alternatively, the granules can be heated and then added to the surface of the polymer base 28. As another example, the granules 10 can be added to the polymer prior to extruding the polymer, such that the granules form occlusions which are not able to be saturated with water, increasing the buoyance of the compound. In this scenario the outer layer of polymer can charred or melted away to expose at least a portion of the outer granules' surface. Uncharred porous organic materials or inorganic porous materials may also be incorporated into the composite formed or serve as an alternative to biochar. If so desired, other materials of higher density can be added to the composite to decrease buoyancy and promote faster settling within the process or to add desirable properties, for example increased cationic exchange capacity. The media can also undergo various treatments to enhance hydrophobicity, hydrophilicity, oleophilicity, oleophobicity, or various other adsorptive properties such as cationic exchange capacity to enhance contaminant adsorption.

Granules 10, clusters 26, and bases 28 having granules 10 thereon are herein collectively referred to as biology carriers 32. Biology carriers 32 can be utilized within processes that utilize separate reactors for anaerobic, aerobic, and/or anoxic processes, as well as within processes that utilize a single reactor to perform anaerobic, aerobic, and/or anoxic processes. If a single reactor is used, anaerobic, aerobic, and anoxic processes may be performed sequentially within that reactor, or may be performed simultaneously within that reactor by taking advantage of the structure of the granules 10 to create aerobic, anoxic, and anaerobic zones.

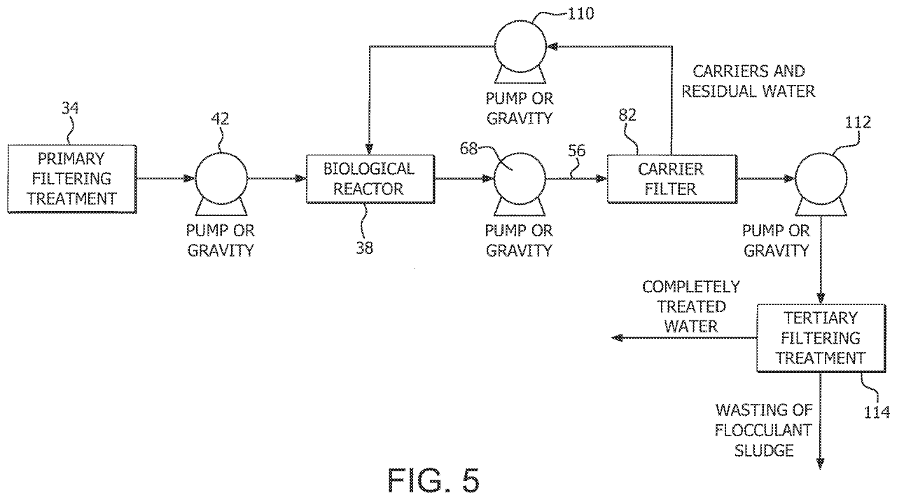

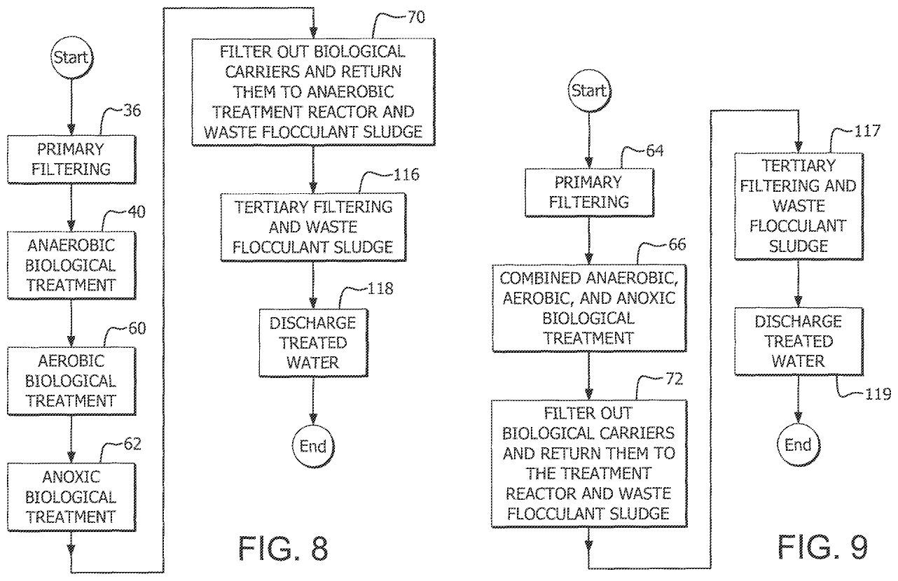

Referring to FIGS. 5 and 8, some examples of wastewater treatment begin with a primary filtering step 34, 36. Examples of primary filtering include U.S. Pat. No. 5,087,358, which was issued to Donato Massignani on Feb. 11, 1992, as well as U.S. Pat. No. 6,500,331, which was issued to Donato Massignani on Dec. 31, 2002. The entire disclosure of both of these patents is expressly incorporated herein by reference. Another example of a primary filtering system is disclosed in US 2023/0002264, which was invented by the present inventors, published on Jan. 5, 2023, and is entitled “Wastewater Treatment System for Improved Primary Treatment and Volatile Fatty Acid Generation,” the entire disclosure of which is expressly incorporated herein by reference. In the example of US 2023/0002264, wastewater is combined with volatile fatty acids prior to beginning secondary treatment or biological treatment. The volatile fatty acids serve as a readily assimilable carbon source for the biology within the biological reactors utilized to drive nitrification/denitrification and phosphorus uptake by the biology. This process should enhance the secondary treatment by removing and converting partially soluble organics to VFA's, allowing the needed carbon to be utilized even in the deeper regions of the granules which are diffusion limited.

Some examples of the treatment process include utilizing an ultraviolet or electrocoagulation device prior to biological treatment of the wastewater in order to make the contaminants within the wastewater more easily removed. In some examples of the treatment process, metal coagulants, salts, acids, bases, or oxidants are also added to the wastewater either prior to or during biological treatment in order to enhance the removal of contaminants. All of these processes and additives are well known to those skilled in the art of water treatment.

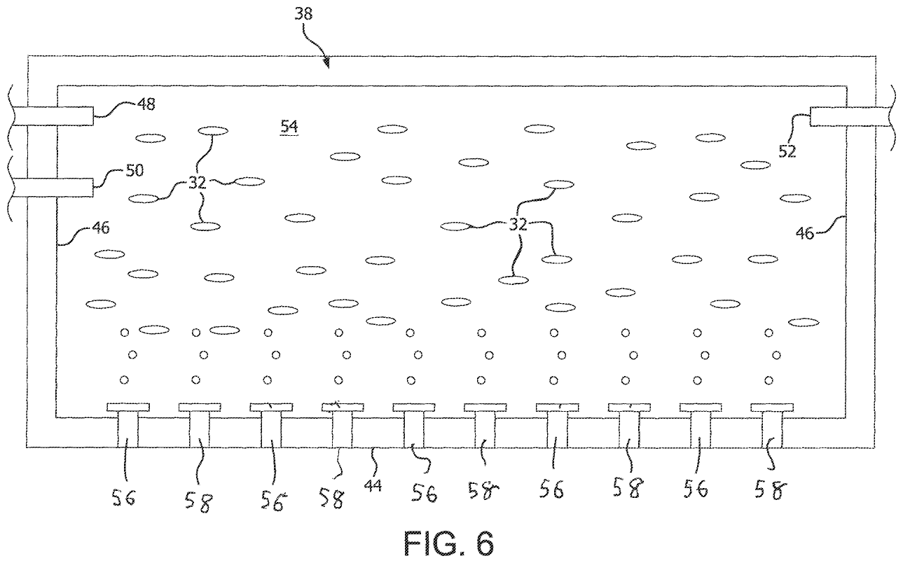

Once primary treatment is complete, the wastewater (and in some examples the volatile fatty acids combined with the wastewater) is added to a reactor 38 at step 40, in the illustrated example utilizing pump 42. Other examples may utilize gravity feed. An example of a reactor 38 is illustrated in FIG. 6. The reactor 38 includes a bottom 44, sides 46 an inlet 48 for receiving wastewater to be treated, an inlet 50 for receiving biology carriers 32 and water returned from filtering (described below), and an outlet 52 for directing treated wastewater to the filter (described below). Numerous biology carriers 32 are suspended within the wastewater 54. Large bubble generators 56 permit air to be injected into the reactor 38 in the form of large bubbles for agitation. The fine bubble diffusers 58 can be used to provide the oxygen for the aerobic process. Various other means can be used to achieve the desired mixing and aeration effect such as mechanical mixing or jet aeration among other means readily known in the field.

Anaerobic, aerobic, and anoxic processes can be performed sequentially. Although not limited to this order, an example biological process begins by injecting large air bubbles and/or providing air at a lower flowrate into the reactor 38 to provide agitation during anaerobic processing at step 40 (FIG. 8), with the large nature of the bubbles or reduced flowrate providing minimal oxygen transfer into the process water to maintain anaerobic conditions. This agitation can also be provided via traditional mechanical or hydraulic mixing technologies as well. Air is injected in small bubbles and/or at a higher flowrate upon completion of anaerobic processing to initiate aerobic processing at step 60. In some examples, the injection of air is controlled in a manner which contributes to the simultaneous use of the processes carried out by the biology as described above, with aerobic processes occurring on the surface and close to openings within the various recesses 18 (zone 20), anoxic processes occurring in central portions of the recesses 18 (zone 22), and anaerobic processes occurring deeper within the recesses 18 (zone 24). In other examples, jet aeration or venturi aeration may be used to control the anaerobic, anoxic, or aerobic nature of the processes occurring within the recesses 18 by controlling the flowrate of air. Once aerobic processing is complete, aeration may be fully or partially reduced for anoxic processing at step 62 to encourage denitrification. This sequencing encourages the biology to selectively compete favoring biology which accomplishes phosphorus release in the anaerobic zone and luxury uptake of the phosphorus in the aerobic zone, providing for a net increase of phosphorus in the biology and yielding an overall reduction of phosphorus in the water to be treated. This sequencing combined with a limited supply of oxygen from the air injected promotes simultaneous nitrification on the surface of the granule and denitrification in the inner regions of the granule where oxygen is limited.

Alternatively, referring to FIG. 9, following the primary filtering step 64, the structure of the granules 10 forming part or all of the biology carriers 32 can be utilized to perform anaerobic, aerobic, and anoxic processes simultaneously at step 66. Because the various biology forming the biofilm on the granules 10 exist in the aerobic regions 20, anoxic regions 22, and anaerobic regions 24 of the recesses or pores 18 (FIG. 2), all three processes occur simultaneously. Utilizing all three processes simultaneously through an aerobic granular sludge type process permits simultaneous removal or assimilation of carbon, nitrogen, and phosphorus. Such a process requires a careful balance between the aerobic and anoxic portions of the granules so that nitrification and de-nitrification occur at the proper rates. Regardless of whether these processes occur sequentially or simultaneously, once they are complete, a pump 68 or gravity flow transfers the water, and inevitably a portion of the biology carriers 32, to the filtering device 82 at step 70 or 72.

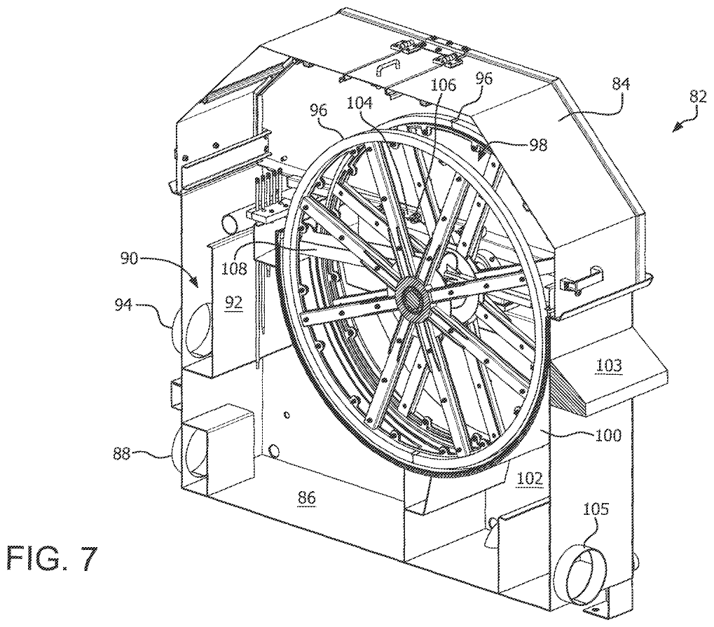

Referring to FIGS. 5, 7, 8, and 9, once biological processing of the water 54 is complete, the water 54 and biology carriers 32 therein are transferred to a filtering device 82 so that the biology carriers 32 can be removed from the water 54 and returned to the reactor 38. Any presently known or later developed filtering device which is suitable for removing the biology carriers 32 from the water may be used. An example of a filtering device 82 is described in U.S. Pat. No. 9,808,747, which was issued to Donato Massignani on Nov. 7, 2017, the entire disclosure of which is expressly incorporated herein by reference. A similar example of a filtering device 82 is illustrated in FIG. 7. The illustrated example of a filtering device 82 has a housing 84. An influent chamber 86 is defined within the housing 84. Water 48 and granules 10 enter the influent chamber 86 through the inlet 88. Some examples may also include an overflow chamber 90 separated from the influent chamber 86 by a wall 92. When the water level within the chamber 86 exceeds the height of the wall 92, water flows into the overflow chamber 90, and through the outlet 94, where it is then directed back into the inlet of the anaerobic process.

A pair of substantially identical filter discs 96 are rotatably secured within the housing 84, and connected by a central shaft to a motor. The filter discs 96 may be flat or conical in nature. A treatment chamber 98 is defined between the discs, as well as by a bottom wall 100 which is in sliding contact with the rotating discs 98. In the illustrated example, each of the filter discs 96 includes an inner course filter screen of approximately 50-1,000 μm adjacent to the treatment chamber 98, and an outer fine filter screen having an approximately 10-50 μm screen, Alternatively the course filter can be in the outer position to provide support for the fine filter screen or can be accomplished with a single fine screen layer of between approximate 10-1,000 μm. A lip seal along the perimeter of each of the discs 98 resist passage of water between the edge of the disc 98 and the wall 100. An effluent chamber 102 is located below the wall 100. A discharge conduit 105 carries filtered water out of the effluent chamber 102.

A pipe 104 is disposed outside of each of the filter discs 96. The pipes 104 include a plurality of nozzles 106 for directing pressurized water against the outside of each of the discs 96. A collecting duct 108 is disposed between the filter discs 96, below the pipe 104.

Water and biology carriers within the influent chamber 86 will enter the treatment chamber 98 between the rotating discs 96. The water will pass through the filter discs 96 into the effluent chamber 102. Biology carriers 32 are unable to pass through the discs 96, and are removed via the chute 103 via the combined rotation of the disks and velocity of the water entering between the disks. Pressurized water from the nozzles 106 pushes the flocculant sludge trapped on the filter discs 96 back into the treatment chamber 98, where they fall into the collecting duct 108. The biology carriers 32, and inevitably some water, are then transferred back to the anaerobic reactor 38 by the pump 110, gravity, or other means of conveyance and the flocculant sludge is wasted from the process to remove nutrients assimilated within. In the illustrated example, filtered water exiting the outlet 105 is carried by the pump 112 or by gravity to a tertiary filtering treatment 114 at step 116, 117 and then discharged at step 118, 119. Other examples may directly discharge the water from the outlet 105.

Other examples of the water treatment system may utilize sedimentation, floatation, or hydraulic separation. Some methods of removing the carriers 10 and flocculant sludge from the treated water may leave the carriers 10 within the reactor 38, rather than removing and then returning the carriers 10. For example, depending on the specific gravity of the carriers 10, they may be permitted to sink to the bottom of the reactor 38 so that water may be removed from the top of the reactor 38. Alternatively, carriers 10 may be permitted to float to the top of the reactor 38 so that water can be withdrawn from a portion of the reactor below the carriers. Unattached biology as well as any organic or inorganic particles are anticipated to sink to the bottom of the reactor 38. Depending on whether removal of this unattached biology and these particles is desirable, water may be removed from the middle of the tank to remove water only, or from the bottom of the tank to remove unattached biology and particles. In examples wherein the flow of water into and out of the reactor 38 is intermittent, stopping mixing at a time when water is not flowing in or out will permit the carriers 10, unattached biology, and other particles within the reactor 38 to float or sink.

As the processes of FIGS. 1, 8, and 9 proceed, it is anticipated that biology and any particulate matter within the reactor 38 may agglomerate to form additional biology carriers 32. Additional biology carriers 32 may also be added as the older biology carriers 32 are broken apart and/or consumed so that a biofilm may form on these biology carriers 32. If the amount of biology carriers becomes excessive, then removing some of these biology carriers may be desirable. These biology carriers 32 can be transferred to another treatment site to initiate the same biological treatment process at the new location. Additionally or alternatively, these biology carriers 32 may be treated physically, chemically, or biologically using methods known to those skilled in the art to remove phosphorus and/or other nutrients therefrom. As another alternative, the biology carriers may be used for agricultural fertilizer. If biochar is utilized within the biology carriers 32, it can result in a carbon negative process by sequestering the carbon which is resistant to biological or chemical degradation within the soil for hundreds of years to come.

The processes described herein can be performed as batch processes, wherein a predetermined volume of water is placed in the reactor 38 and then remains in the reactor until fully biologically treated and proceeds to filtering. Alternatively, the processes may be performed continuously, with wastewater continuously entering and exiting the reactor 38, and biology carriers 32 being continuously separated by filtration and returned to the reactor 38. In yet another form, the biology carriers 32 are retained via hydraulic separation, where the rapidly settling biology carriers 32 are retained and slower settling flocculant sludge is wasted from the process. In another form, the biologically treated water is separated from the biology carriers 32 and flocculant sludge via gravity settling and then the flocculant sludge is separated from the biology carriers 32 via filtration as described earlier, with the flocculant sludge being wasted and the biology carriers 32 returned to the anaerobic process stage.

The present invention therefore provides a means of biologically treating wastewater using simultaneous aerobic, anaerobic, and anoxic processes. Aerobic, anoxic, and anaerobic zones are created on each biology carrier, and are determined by the depth of the biology within the pores or recesses of the biology carrier. The process can be accomplished with reduced physical space, reduced energy, and more quickly as compared to prior biological treatment processes. The specific gravity and particle density of the biology carriers facilitates keeping the biology carriers suspended in and distributed around the wastewater, while also facilitating settling of the biology carriers when desired. The biological treatment process reduces the quantity of organic carbon, nitrogen, and phosphorus and the biology carriers along with the biological degradation may also aid in the adsorption of contaminants of emerging concern such as perfluorinated compounds, 1,2,3-trichloropropane, 1,4-dioxane, 2,4,6-trinitrotoluene, dinitrotoluene, hexahydro-1,3-5-trinitro-1,3,5-triazine, N-nitroso-dimethylamine, perchlorate oxidants, and other contaminants within the wastewater via adsorption. The treatment process utilizes biology carriers made at least in part from charred biological waste, making the biology carriers resist biological degradation, robust, and to be readily habitable verses traditional aerobic granules which often takes many months to be generated by the biology or sometimes fail to form at all. Partially charred wastes may also potentially be added to provide a supplemental carbon source for the biology that lives thereon if the system is carbon limited, thereby ensuring the availability of this biology for the treatment process. The possible addition of volatile fatty acids further ensures that the biology has an adequate source of carbon to drive the biological process regardless of whether the biology exists in the aerobic, anoxic, or anaerobic zone of a biology carrier.

A variety of modifications to the above-described embodiments will be apparent to those skilled in the art from this disclosure. Thus, the invention may be embodied in other specific forms without departing from the spirit or essential attributes thereof. The particular embodiments disclosed are meant to be illustrative only and not limiting as to the scope of the invention. The appended claims, rather than to the foregoing specification, should be referenced to indicate the scope of the invention.

What is claimed is:

1. A biological wastewater treatment method, comprising:
providing at least one biological reactor;
providing biology carriers within the at least one biological reactor;
permitting biology to form on the biology carriers;
providing wastewater into the at least one biological reactor;
treating the wastewater anaerobically within at least one of the biological reactors, and treating the wastewater aerobically within at least one of the biological reactors, to produce biologically treated water;
separating the biology carriers from a majority of the biologically treated water; and
returning the biology carriers to one of the at least one biological reactors or retaining the biology carriers within the biological reactor.

2. The method according to claim 1, further comprising treating the wastewater anoxically within at least one of the biological reactors.

3. The method according to claim 2, wherein the anaerobic, aerobic, and anoxic treatment occur simultaneously for at least a portion of treating the wastewater anaerobically, aerobically, and anoxically within the biological reactor.

4. The method according to claim 3, wherein the biological carrier defines a plurality of recesses, the recesses containing biology, each of the recesses defining an outside portion, an inside portion, and a central portion therebetween, the outside portion supporting aerobic treatment by biology thereon, the central portion supporting anoxic treatment by bacteria thereon, and the inner portion supporting anaerobic treatment by bacteria thereon.

5. The method according to claim 4, wherein at least a portion of treating the wastewater anaerobically, aerobically, and anoxically within the biological reactor occurs simultaneously as a result of the outside portion, inside portion, and central portion defined by the recesses defined by the biological carrier.

6. The method according to claim 1, wherein the anaerobic and aerobic treatment occur simultaneously for at least a portion of treating the wastewater anaerobically and aerobically within the biological reactor.

7. The method according to claim 6, wherein the biological carrier defines a plurality of recesses, the recesses containing biology, each of the recesses defining an outside portion and an inside portion, the outside portion supporting aerobic treatment by biology thereon, and the inner portion supporting anaerobic treatment by bacteria thereon.

8. The method according to claim 7, wherein at least a portion of treating the wastewater anaerobically and aerobically within the biological reactor occurs simultaneously as a result of the outside portion and inside portion defined by the recesses defined by the biological carrier.

9. The method according to claim 1, wherein the biology carriers have a saturated specific gravity of about 0.8 to about 1.5.

10. The method according to claim 1, wherein the biology carriers are made at least partially from biological materials.

11. The method according to claim 10, wherein the biology carriers are made at least partially from biochar.

12. The method according to claim 1, wherein the biological reactor is a single tank wherein anaerobic, aerobic, and anoxic treatment are performed.

13. The method according to claim 12, wherein:
the single tank includes bubble aerators, jet aerators, or venturi aerators, the bubble aerators, jet aerators, or venturi aerators being structured to provide a variable air flowrate; and
anaerobic, aerobic, or anoxic processes are initiated by varying the air flowrate.

14. The method according to claim 1, wherein:
the biology carriers have a specific gravity of about 1.0 to about 1.5; and
separating the biology carriers from the biologically treated water is performed by permitting the biology carriers to settle, and then removing biologically treated water from above the settled biology carriers.

15. The method according to claim 1, wherein:
the biology carriers have a specific gravity of about 0.8 to about 1.0; and
separating the biology carriers from the biologically treated water is performed by permitting the biology carriers to float in an upper portion of the biological reactor, and then removing biologically treated water from below the biology carriers.

16. The method according to claim 1, further comprising combining the wastewater with volatile fatty acids prior to treating the wastewater anaerobically, aerobically, and anoxically within the biological reactor.

17. The method according to claim 1:
wherein the biologically treated water has flocculant biology or biology which has become detached from carriers; and
further comprising removing a portion of the flocculant biology or the biology which has become detached from the carriers from the biologically treated water.

18. The method according to claim 1:
wherein the biologically treated water remaining with the biology carriers after separation of the biology carriers from a majority of the biologically treated water has flocculant biology or biology which has become detached from carriers; and
further comprising removing a portion of the flocculant biology or the biology which has become detached from the biologically treated water remaining with the biology carriers prior to reintroducing the biology carriers to the reactor.
